(19) United States
(12) Patent Application Publication
(10) Pub. No.: US 2026/0204066 A1
(43) Pub. Date: Jul. 16, 2026

(54) METHOD FOR VIDEO UNDERSTANDING, APPARATUS, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Weixin LIU, Beijing (CN); Xintong YU, Beijing (CN); Shikun FENG, Beijing (CN)

(73) Assignee: BEIJING BAIDU NETCOM SCIENCE TECHNOLOGY CO., LTD., Beijing (CN)

(21) Appl. No.: 19/464,413

(22) Filed: Jan. 29, 2026

(30) Foreign Application Priority Data
Jun. 5, 2025 (CN) 202510748870.5

(51) Int. Cl. G06V 20/40; G06V 10/62; G06V 10/75; G06V 20/62; G10L 15/04; G10L 15/18; G10L 25/57

(52) U.S. Cl. CPC G06V 20/41; G06V 10/62; G06V 10/757; G06V 20/46; G06V 20/63; G10L 15/04; G10L 15/1815; G10L 25/57

(57) ABSTRACT

A method for video understanding, an apparatus, an electronic device, and a storage medium are disclosed, which relates to artificial intelligence fields such as deep learning, large models, computer vision and natural language processing. The method includes: sampling a video to be processed to obtain M sampled original images, wherein M is a positive integer greater than 1; obtaining a text recognition result of audio corresponding to the video to be processed; determining a target input information based on the respective original images and the text recognition result; inputting the target input information into a video understanding model to obtain a video understanding result corresponding to the video to be processed.

The present application claims the priority of Chinese Patent Application No.202510748870.5, filed on June 5, 2025, with the title of “METHOD FOR VIDEO UNDERSTANDING, APPARATUS, ELECTRONIC DEVICE, AND STORAGE MEDIUM”. The disclosure of the above application is incorporated herein by reference in its entirety.

### FIELD OF THE DISCLOSURE

The present application relates to the field of artificial intelligence technology, particularly to fields such as deep learning, large models, computer vision and natural language processing, and especially to a method for video understanding, an apparatus, an electronic device, and a storage medium.

### BACKGROUND OF THE DISCLOSURE

Video understanding refers to a process of parsing, analyzing and reasoning video content through artificial intelligence technology. Currently, video understanding technology has been widely applied in different scenarios. For example, content summarization information for a given video segment can be generated.

### SUMMARY OF THE DISCLOSURE

The present application provides a method for video understanding, an apparatus, an electronic device, and a storage medium.

A method for video understanding, including:

sampling a video to be processed to obtain M sampled original images, wherein M is a positive integer greater than 1;

obtaining a text recognition result of audio corresponding to the video to be processed;

determining a target input information based on the respective original images and the text recognition result;

inputting the target input information into a video understanding model to obtain a video understanding result corresponding to the video to be processed.

An electronic device, including:

at least one processor; and

a memory communicatively connected with the at least one processor;

wherein the memory stores instructions executable by the at least one processor, and the instructions are executed by the at least one processor to enable the at least one processor to perform a method for video understanding, wherein the method for video understanding includes:

sampling a video to be processed to obtain M sampled original images, wherein M is a positive integer greater than 1;

obtaining a text recognition result of an audio corresponding to the video to be processed;

determining a target input information based on the respective original images and the text recognition result;

inputting the target input information into a video understanding model to obtain a video understanding result corresponding to the video to be processed.

A non-transitory computer readable storage medium with computer instructions stored thereon, wherein the computer instructions are used for causing a method for video understanding, wherein the method for video understanding includes:

sampling a video to be processed to obtain M sampled original images, wherein M is a positive integer greater than 1;

obtaining a text recognition result of audio corresponding to the video to be processed;

determining a target input information based on the respective original images and the text recognition result;

inputting the target input information into a video understanding model to obtain a video understanding result corresponding to the video to be processed.

It should be understood that the content described in this section is not intended to identify key or essential features of embodiments of the present application, nor is the content used to limit the scope of the present application. Other features of the present application will become readily understandable through the following specification.

### BRIEF DESCRIPTION OF DRAWINGS

The drawings are used to better understand the present scheme and do not constitute a limitation on the present disclosure. In the drawings:

FIG. 1 is the flowchart of a method for video understanding according to a first embodiment of the present application;

FIG. 2 is the schematic diagram of a process of obtaining respective fusion results of the present application;

FIG. 3 is the schematic diagram of a composition method of a second feature sequence of the present application;

FIG. 4 is the flowchart of a method for video understanding according to a second embodiment of the present application;

FIG. 5 is the schematic diagram showing the composition structure of an apparatus 500 for video understanding according to an embodiment of the present application;

FIG. 6 is the schematic block diagram of an electronic device 600 that can be used to implement embodiments of the present application.

### DETAILED DESCRIPTION OF PREFERRED EMBODIMENTS

The following description of exemplary embodiments of the present application is made with reference to the accompanying drawings, which includes various details of the embodiments of the present application to aid understanding, and should be considered merely exemplary. Therefore, those skilled in the art should recognize that various changes and modifications can be made to the embodiments described herein without departing from the scope and spirit of the present application. Similarly, for clarity and conciseness, descriptions of known functions and structures are omitted in the following description.

Furthermore, it should be understood that the term “and/or” herein is merely a description of an association relationship of associated objects, indicating that three relationships can exist, for example, A and/or B, can indicate: only A exists, both A and B exist, and only B exists. In addition, the character “/” herein generally indicates that the associated objects before and after are in an “or” relationship.

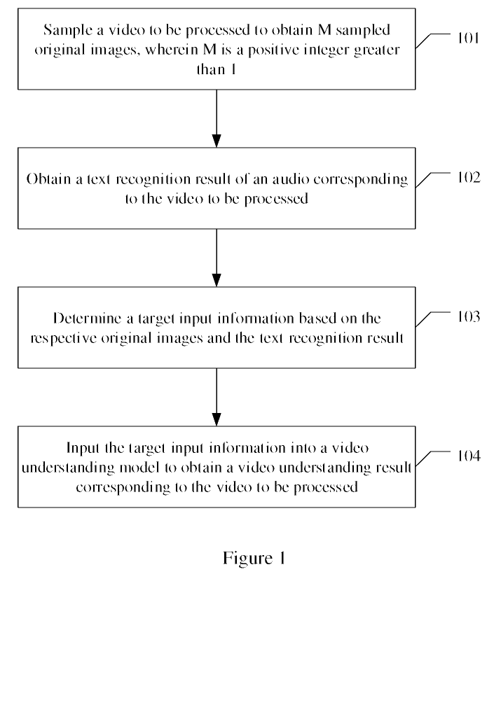

FIG. 1 is the flowchart of a method for video understanding according to a first embodiment of the present application. As shown in FIG. 1, the method includes the following specific implementation of:

In step 101, sampling a video to be processed to obtain M sampled original images, wherein M is a positive integer greater than 1.

In step 102, obtaining a text recognition result of an audio corresponding to the video to be processed.

In step 103, determining a target input information based on the respective original images and the text recognition result.

In step 104, inputting the target input information into a video understanding model to obtain a video understanding result corresponding to the video to be processed.

In traditional methods for video understandings, the video understanding result is typically generated directly based on respective sampled images after a video to be processed is sampled. However, the accuracy of the video understanding result generated in this way is usually poor.

By adopting the scheme described in the method of the embodiment of the present application, in addition to obtaining M sampled original images, a text recognition result of an audio corresponding to a video to be processed can be obtained. In this way, an audio in a video is also considered an important source of information, which can also play an important role in video understanding. Therefore, the target input information can be determined in combination with respective original images and the text recognition result, and the target input information can be input into a video understanding model to obtain a required video understanding result. Accordingly, the accuracy of the obtained video understanding result can be improved. In addition, preferably, the video understanding model can be a multimodal large model, and with a powerful reasoning capability of the video understanding model, the accuracy of the obtained video understanding result can be further improved. A specific value of M can be determined according to an actual situation.

A video to be processed usually includes a large number of frames of images. In order to reduce the workload of subsequent processing, samplings can be performed on the video to be processed. The scheme described in the present application does not limit how to perform a sampling. For example, the sampling can be performed in a manner of collecting two frames of images per second (collecting one frame of image every 0.5 seconds).

In some embodiments of the present application, an automatic speech recognition (ASR) algorithm can be used to perform speech recognition on the audio corresponding to the video to be processed, thereby obtaining a required text recognition result. The text recognition result includes N recognized text segments, N is a positive integer greater than 1. Respective text segments correspond respectively to an audio segment including a complete semantic. The specific value of N can also be determined according to an actual situation.

When an ASR algorithm is used to perform speech recognition on the audio, semantic completeness (paragraphing) is considered, so as to ensure that a semantically complete piece of content, such as a sentence, will not be split into two or even more segments, thereby improving information integrity.

In addition, in some embodiments of the present application, when determining the target input information based on respective original images and the text recognition result, a timestamp information of respective original images can be obtained respectively. A target visual feature can be determined based on the respective original images and the respective timestamp information, and a target text feature can be determined based on the text recognition result. Then the target input information can be determined based on the target visual feature and the target text feature.

The biggest difference between a video and an image is that the video has temporality. Therefore, how to model temporality of different frame images will also affect the result of video understanding. Accordingly, in a scheme described in the present application, the timestamp information of respective sampled original images can be obtained respectively, and a target visual feature can be determined based on the respective original images and the respective timestamp information.

In some embodiments of the present application, respective timestamp information can be rendered to a predetermined position in a corresponding original image respectively to obtain each target image. Then a target visual feature can be determined based on respective target images.

The predetermined position is not limited to a specific type of position, and can be determined according to an actual need. The specific format of rendered timestamp information can also be determined according to an actual need. By rendering the timestamp information directly onto an original image, it can facilitate the video understanding model to obtain the timestamp information, thereby improving the processing efficiency of the video understanding model.

In addition, in some embodiments of the present application, for any original image, in response to being able to obtain absolute time information of the original image, the absolute time information can be determined as timestamp information of the original image. In response to not being able to obtain the absolute time information, a start time of a video to be processed can be determined as a moment 0, and relative time information of the original image relative to the moment 0 can be obtained. Then the relative time information can be determined as the timestamp information of the original image.

That is to say, an absolute time information can be obtained with priority, so as to facilitate a video understanding model to better analyze and understand video content. For example, the video understanding model can be facilitated to better determine whether an event in a video to be processed occurs in the morning or in the afternoon, and so on. If the absolute time information cannot be obtained, a relative time information can be obtained. For example, for a video such as a surveillance video or a recorded video, it is relatively easy to obtain the absolute time information of respective frames of original image. But for videos downloaded by a user from a video platform, it is usually difficult to obtain the absolute time information of respective frames of original image.

In some embodiments of the present application, when determining a target visual feature based on respective target images, an original visual feature of respective target images can be obtained respectively. Then respective original visual features can be sorted according to corresponding timestamp information from earlier to later. Respective original visual features at an odd position can be fused with a next adjacent original visual feature respectively, and then respective fusion results can be determined as the target visual feature.

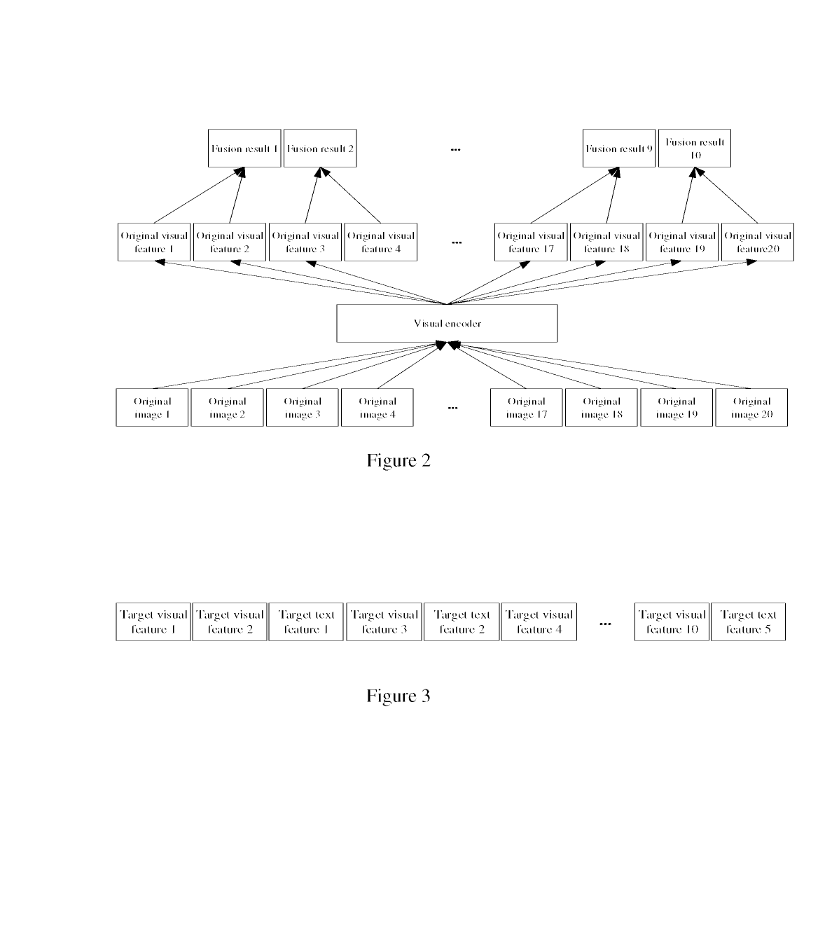

FIG. 2 is the schematic diagram of a process of obtaining respective fusion results of the present application. As shown in FIG. 2, assuming that 20 frames of original images are sampled in total, which are original image 1 to original image 20, then a visual encoder can be used to generate a visual feature of respective original images respectively. In order to distinguish from a fused visual feature, the visual feature of respective original images can be referred to as an original visual feature, then respective original visual features can be sorted according to corresponding timestamp information in an order from earlier to later. Assuming that the respective sorted original visual features are original visual feature 1 to original visual feature 20, then original visual feature 1 and original visual feature 2, original visual feature 3 and original visual feature 4, original visual feature 5 and original visual feature 6, original visual feature 7 and original visual feature 8, original visual feature 9 and original visual feature 10, original visual feature 11 and original visual feature 12, original visual feature 13 and original visual feature 14, original visual feature 15 and original visual feature 16, original visual feature 17 and original visual feature 18, and original visual feature 19 and original visual feature 20 can be fused respectively, so as to obtain fusion result 1, fusion result 2, fusion result 3, fusion result 4, fusion result 5, fusion result 6, fusion result 7, fusion result 8, fusion result 9, and fusion result 10 respectively. Further, respective fusion results can be determined as a required target visual feature.

Through fusion, the workload of subsequent processing can be further reduced. Moreover, in a scheme described in the present application, the fusion is performed on an original visual feature of an original image, rather than on the original image. The fusion on the original image can refer to: sorting respective collected frames of original image according to corresponding timestamp information from earlier to later, then fusing two adjacent original images, that is, fusing pixels at the same position of the two adjacent frames of original image, and then obtaining a visual feature of respective fused images respectively. But when a video changes greatly, that is, when content of the two adjacent frames of original image differs greatly, this fusion manner can lead to information confusion, affecting acquisition of useful information. According to the scheme described in the present application, a manner of first obtaining the original visual feature of respective frames of original image and then fusing the original visual feature is adopted. That is, the pixel-level fusion is changed to the feature-level fusion, which can avoid these situations to a great extent. This is because when obtaining the original visual feature of the original image, the information at different positions can interact with each other. In addition, the obtained original visual feature carries semantic information, thereby improving an accuracy of a fusion result. Moreover, how to fuse two original visual features is not limited. For example, a convolutional fusion manner can be adopted.

In addition to determining a target visual feature, a target text feature also needs to be determined based on a text recognition result of audio corresponding to a video to be processed.

In some embodiments of the present application, a text recognition result can include N recognized text segments, N is a positive integer greater than 1. Respective text segments correspond respectively to an audio segment that includes a complete semantic. Accordingly, a text feature corresponding to respective text segments can be determined respectively, and the text features corresponding to respective text segments can be determined as a target text feature.

For example, assuming that there are 5 text segments in total, which are text segment 1 to text segment 5, then a text feature corresponding to text segment 1 to text segment 5, that is, text feature 1 to text feature 5, can be obtained respectively, and then text feature 1 to text feature 5 can be determined as a target text feature respectively.

In some embodiments of the present application, for any text segment, the following processing can be performed respectively: obtaining a timestamp information of an audio segment corresponding to the text segment, the timestamp information of the audio segment includes: a start time timestamp of the audio segment and an end time timestamp of the audio segment, concatenating the timestamp information with the text segment, and obtaining a text feature of a concatenation result, determining the text feature of the concatenation result as a text feature corresponding to the text segment.

Concatenating timestamp information with a text segment can refer to concatenating the timestamp information in a text form before or after the text segment, so as to facilitate a video understanding model to better understand time information corresponding to different text segments respectively.

In addition, for any text segment with concatenated timestamp information, a text encoder or the like can be used to obtain a text feature of the text segment respectively.

In some embodiments of the present application, a manner of obtaining timestamp information of an audio segment corresponding to any text segment can include: in response to being able to obtain absolute time information of the audio segment, determining the absolute time information as the timestamp information of the audio segment, in response to not being able to obtain the absolute time information, obtaining relative time information of the audio segment relative to a moment 0 (a start time of a video to be processed), determining the relative time information as the timestamp information of the audio segment. That is, the absolute time information is obtained with priority.

After a target visual feature and a target text feature are obtained respectively, the target input information can be determined based on the target visual feature and the target text feature.

In some embodiments of the present application, the respective target visual features can be sorted according to corresponding timestamp information from earlier to later, and the respective sorted target visual features can be added to a first feature sequence. The first feature sequence is initially empty, then for respective target text features, the following processing can be performed respectively: screening, from the respective target visual features, a target visual feature that meets the following condition: the timestamp information of corresponding two original images are both within a predetermined time range, the predetermined time range is a time range defined by a start time timestamp to an end time timestamp of an audio segment corresponding to the target text feature, determining the screened target visual feature as a matching visual feature, and adding the target text feature to an adjacent position after the matching visual feature that has a latest sorting position, and then determining a first feature sequence after adding the respective target visual features and the respective target text features as a second feature sequence, and determining a target input information based on the second feature sequence.

FIG. 3 is the schematic diagram of a composition method of a second feature sequence of the present application. As shown in FIG. 3, assuming that 10 target visual features are obtained in total, which are target visual feature 1 to target visual feature 10 after sorting, and assuming that a duration of a video to be processed is 10 seconds, and 20 frames of original images are sampled from the video to be processed in a manner of collecting two frames of images per second. The target visual feature 1 is generated based on two frames of original images collected from the first second of the video to be processed, the target visual feature 2 is generated based on two frames of original images collected from the second second of the video to be processed, ..., the target visual feature 10 is generated based on two frames of original images collected from a tenth second of the video to be processed. Assuming that 5 target text features are obtained in total, which are target text feature 1 to target text feature 5, taking target text feature 1 as an example, assuming that timestamp information of an audio segment corresponding to the target text feature 1 is from the 0th second to the 2nd second of the video to be processed, then target visual feature 1 and target visual feature 2 can be determined as matching visual features. The target text feature 1 can be added to an adjacent position after target visual feature 2, that is, a position between target visual feature 2 and target visual feature 3.

It can be seen that after the above processing, an obtained second feature sequence includes the respective target visual features in an order from earlier to later, and the respective target text feature are added after a corresponding target visual feature respectively, so as to facilitate analysis and understanding by a video understanding model, thereby improving the processing efficiency and the accuracy of the processing result of the video understanding model.

After a second feature sequence is obtained, the target input information can be further determined based on the second feature sequence.

In some embodiments of the present application, a text feature of a processing instruction corresponding to a video to be processed can be obtained, and the processing instruction is the instruction information obtained together with the video to be processed and for describing a video understanding requirement for the video to be processed. Then a second feature sequence and the text feature of the processing instruction can be determined as the target input information.

In an actual application, when a user has a video understanding requirement, in addition to providing a video to be processed, the user usually also provides a corresponding processing instruction, such as “what is the main content introduced in this video”. Accordingly, a text feature of the processing instruction can also be obtained. The second feature sequence and the text feature of the processing instruction can be used together as the target input information which is input into a video understanding model, so as to facilitate the video understanding model to better understand a user requirement, thereby further improving the accuracy of a generated video understanding result.

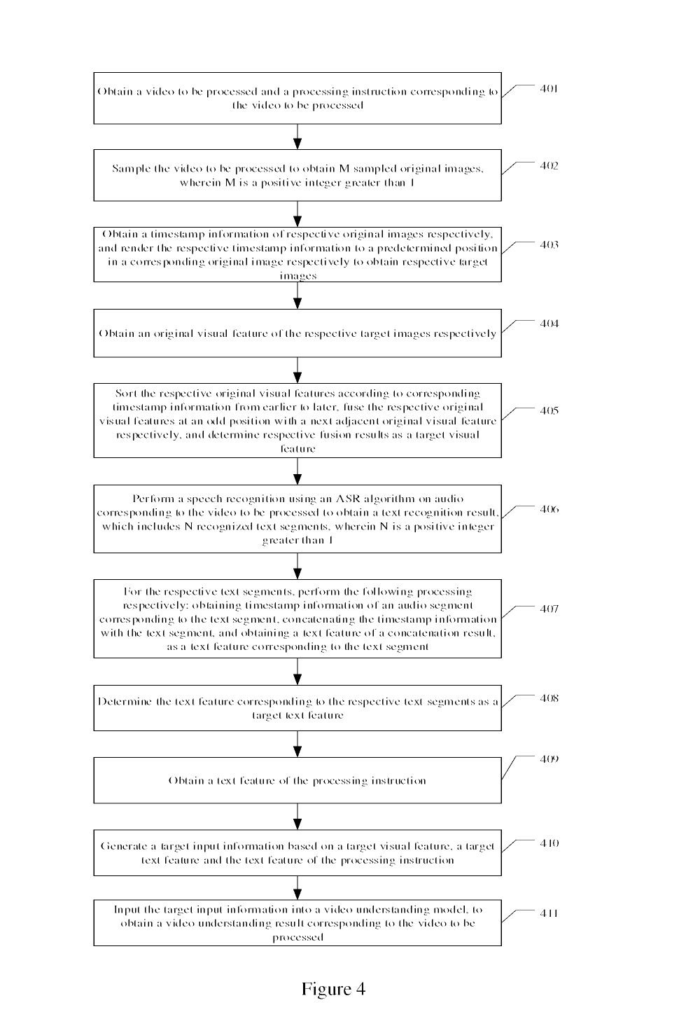

Combined with the above introduction, FIG. 4 is the flowchart of a method for video understanding according to a second embodiment of the present application. As shown in FIG. 4, the second embodiment includes the following specific implementation of:

In step 401, obtaining a video to be processed and a processing instruction corresponding to the video to be processed.

In step 402, sampling the video to be processed to obtain M sampled original images, wherein M is a positive integer greater than 1.

In step 403, obtaining a timestamp information of respective original images respectively, and rendering the respective timestamp information to a predetermined position in a corresponding original image respectively to obtain respective target images.

In step 404, obtaining an original visual feature of the respective target images respectively.

In step 405, sorting the respective original visual features according to corresponding timestamp information from earlier to later, fusing the respective original visual features at an odd position with a next adjacent original visual feature respectively, and determining respective fusion results as a target visual feature.

In step 406, performing a speech recognition using an ASR algorithm on audio corresponding to the video to be processed to obtain a text recognition result, which includes N recognized text segments, wherein N is a positive integer greater than 1.

In step 407, for the respective text segments, performing the following processing respectively: obtaining timestamp information of an audio segment corresponding to the text segment, concatenating the timestamp information with the text segment, and obtaining a text feature of a concatenation result, as a text feature corresponding to the text segment.

In step 408, determining the text feature corresponding to the respective text segments as a target text feature.

In step 409, obtaining a text feature of the processing instruction.

In step 410, generating a target input information based on a target visual feature, a target text feature and the text feature of the processing instruction.

In step 411, inputting the target input information into a video understanding model, to obtain a video understanding result corresponding to the video to be processed.

It should be noted that, for the foregoing method embodiments, for the sake of simple description, they are all described as a series of action combinations. However, those skilled in the art should appreciate that the present application is not limited by the described action sequence, because according to the present application, some steps can be performed in other orders or simultaneously. For example, steps 402 to 405, steps 406 to 408, and step 409 can be performed simultaneously. Secondly, those skilled in the art should also appreciate that the embodiments described in the specification are all preferred embodiments, and the involved actions and modules are not necessarily essential to the present application. In addition, for parts not detailed in an embodiment, reference can be made to relevant descriptions in other embodiments.

The above is an introduction to the method embodiments, and the following further describes the scheme of the present application through apparatus embodiments.

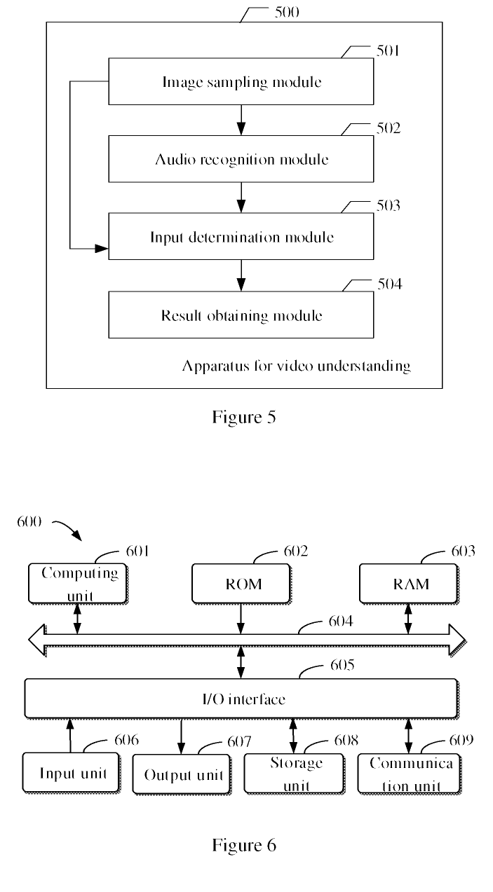

FIG. 5 is the schematic diagram showing the composition structure of an apparatus 500 for video understanding according to an embodiment of the present application. As shown in FIG. 5, the apparatus includes: an image sampling module 501, an audio recognition module 502, an input determination module 503, and a result obtaining module 504.

The image sampling module 501 is configured to sample a video to be processed to obtain M sampled original images, wherein M is a positive integer greater than 1.

The audio recognition module 502 is configured to obtain a text recognition result of audio corresponding to the video to be processed.

The input determination module 503 is configured to determine a target input information based on the respective original images and the text recognition result.

The result obtaining module 504 is configured to input the target input information into a video understanding model to obtain a video understanding result corresponding to the video to be processed.

In some embodiments of the present application, when the input determination module 503 determines the target input information based on respective original images and the text recognition result, the input determination module 503 can obtain the timestamp information of respective original image respectively, and can determine a target visual feature based on the respective original images and the respective timestamp information. It then can determine a target text feature based on the text recognition result, and then can determine the target input information based on the target visual feature and the target text feature.

In some embodiments of the present application, the input determination module 503 can render respective timestamp information to a predetermined position in a corresponding original image respectively to obtain respective target images, and then can determine a target visual feature based on respective target images.

In some embodiments of the present application, when the input determination module 503 determines a target visual feature based on respective target images, the input determination module 503 can obtain an original visual feature of respective target images respectively, then can sort respective original visual features according to corresponding timestamp information from earlier to later, and can fuse respective original visual features at an odd position with a next adjacent original visual feature respectively, and then can determine respective fusion results as the target visual feature.

In addition, in some embodiments of the present application, the audio recognition module 502 can use an ASR algorithm to perform speech recognition on audio corresponding to a video to be processed, so as to obtain a required text recognition result, and the text recognition result includes N recognized text segments, N is a positive integer greater than 1. Respective text segments corresponds respectively to an audio segment including complete semantic. Accordingly, the input determination module 503 can determine a text feature corresponding to respective text segments respectively, and can determine the text feature corresponding to respective text segments as a target text feature.

In some embodiments of the present application, for any text segment, the input determination module 503 can perform the following processing respectively: obtaining timestamp information of an audio segment corresponding to the text segment, the timestamp information of the audio segment includes: a start time timestamp of the audio segment and an end time timestamp of the audio segment, concatenating the timestamp information with the text segment, obtaining a text feature of a concatenation result, and determining the text feature of the concatenation result as a text feature corresponding to the text segment.

In some embodiments of the present application, a manner in which the input determination module 503 obtains the timestamp information of respective original images respectively can include: for any original image, in response to being able to obtain absolute time information of the original image, determining the absolute time information as the timestamp information of the original image, in response to not being able to obtain the absolute time information, determining a start time of a video to be processed as a moment 0, and obtaining relative time information of the original image relative to the moment 0, determining the relative time information as the timestamp information of the original image. A manner in which the input determination module 503 obtains timestamp information of an audio segment corresponding to any text segment can include: in response to being able to obtain absolute time information of the audio segment, determining the absolute time information as the timestamp information of the audio segment, in response to not being able to obtain the absolute time information, obtaining relative time information of the audio segment relative to the moment 0, determining the relative time information as the timestamp information of the audio segment.

After the target visual feature and the target text feature are obtained respectively, the input determination module 503 can determine target input information based on the target visual feature and the target text feature.

In some embodiments of the present application, the input determination module 503 can sort respective target visual features according to corresponding timestamp information from earlier to later, and can add the respective sorted target visual features into a first feature sequence, and the first feature sequence is initially empty. Then for respective target text features, it can perform the following processing respectively: screening, from respective target visual features, a target visual feature that meets the following condition: timestamp information of corresponding two original images are both within a predetermined time range, the predetermined time range is a time range defined by a start time timestamp to an end time timestamp of an audio segment corresponding to the target text feature, determining the screened target visual feature as a matching visual feature, and adding the target text feature to an adjacent position after the matching visual feature that has a latest sorting position, and then determining a first feature sequence after adding the respective target visual features and the respective target text features as a second feature sequence, and determining the target input information based on the second feature sequence.

In some embodiments of the present application, the input determination module 503 can obtain a text feature of a processing instruction corresponding to a video to be processed, and the processing instruction is instruction information obtained together with the video to be processed and for describing a video understanding requirement for the video, and then can determine a second feature sequence and the text feature of the processing instruction as target input information.

Further, the result obtaining module 504 can input the target input information into a video understanding model, so as to obtain a video understanding result corresponding to the video to be processed.

A specific workflow of the apparatus embodiment shown in FIG. 5 can refer to the relevant descriptions in the foregoing method embodiments and will not be repeated here.

A scheme of the present application can be applied in an artificial intelligence field, particularly involving fields such as deep learning, large models, computer vision and natural language processing. Artificial intelligence is a discipline that studies how to make a computer simulate certain thinking processes and intelligent behaviors of human (such as learning, reasoning, thinking, planning, etc.), including both hardware-level technologies and software-level technologies. Artificial intelligence hardware technologies generally include technologies such as a sensor, a dedicated artificial intelligence chip, cloud computing, distributed storage, big data processing, etc. Artificial intelligence software technologies mainly include several major directions such as computer vision technology, speech recognition technology, natural language processing technology, and machine learning/deep learning, big data processing technology, knowledge graph technology, etc.

In addition, an image and a video understanding result and so on in the embodiments of the present application are not directed to a specific user, and cannot reflect personal information of a specific user. In a technical scheme of the present application, the collection, storage, use, processing, transmission, provision, and disclosure of user personal information involved comply with provisions of relevant laws and regulations, and do not violate public order and good customs.

According to embodiments of the present application, the present application further provides an electronic device, a readable storage medium, and a computer program product.

FIG. 6 shows a schematic block diagram of an electronic device 600 that can be used to implement embodiments of the present application. The electronic device is intended to represent various forms of digital computers, such as a laptop computer, a desktop computer, a workstation, a server, a blade server, a mainframe computer, and other suitable computers. The electronic device can also represent various forms of mobile devices, such as a personal digital assistant, a cellular telephone, a smart phone, a wearable device, and other similar computing devices. The components shown herein, their connections and relationships, and their functions are merely examples, and are not intended to limit implementations of the present application described and/or claimed herein.

As shown in FIG. 6, the electronic device 600 includes a computing unit 601, which can execute various appropriate actions and processing according to a computer program stored in a Read-Only Memory (ROM) 602 or a computer program loaded from a storage unit 608 to a Random Access Memory (RAM) 603. Various programs and data required for operation of the electronic device 600 can also be stored in the RAM 603. The computing unit 601, the ROM 602, and the RAM 603 are connected to each other through a bus 604. An Input/Output (I/O) interface 605 is also connected to the bus 604.

A plurality of components in the electronic device 600 are connected to the I/O interface 605, including: an input unit 606, for example, a keyboard, a mouse, etc.; an output unit 607, for example, various types of displays, speakers, etc.; a storage unit 608, for example, a magnetic disk, an optical disk, etc.; and a communication unit 609, for example, a network card, a modem, a wireless communication transceiver, etc. The communication unit 609 allows the electronic device 600 to exchange information/data with other devices through a computer network such as the Internet and/or various telecommunication networks.

The computing unit 601 can be various general-purpose and/or special-purpose processing components with processing and computing capabilities. Some examples of the computing unit 601 include, but are not limited to, a Central Processing Unit (CPU), a Graphic Processing Unit (GPU), various dedicated Artificial Intelligence (AI) computing chips, various computing units that run machine learning model algorithms, a Digital Signal Processor (DSP), and any appropriate processor, controller, microcontroller, etc. The computing unit 601 executes the various methods and processing described above, for example, the method described in the present application. For example, in some embodiments, the method described in the present application can be implemented as a computer software program, which is tangibly contained in a machine-readable medium, for example, the storage unit 608. In some embodiments, part or all of a computer program can be loaded and/or installed onto the electronic device 600 via the ROM 602 and/or the communication unit 609. When the computer program is loaded to the RAM 603 and executed by the computing unit 601, one or more steps of the method described in the present application can be executed. Alternatively, in other embodiments, the computing unit 601 can be configured to execute the method described in the present application by any other appropriate means (for example, by means of firmware).

Various implementations of the systems and technologies described herein can be implemented in a digital electronic circuit system, an integrated circuit system, a Field Programmable Gate Array (FPGA), an Application Specific Integrated Circuit (ASIC), an Application Specific Standard Parts (ASSP), a System on Chip (SOC), a Complex Programmable Logic Device (CPLD), computer hardware, firmware, software, and/or combinations thereof. These various implementations can include: implementation in one or more computer programs that are executable and/or interpretable on a programmable system including at least one programmable processor, which can be a special-purpose or general-purpose programmable processor, can receive data and instructions from, and transmit data and instructions to, a storage system, at least one input device, and at least one output device.

Program code for implementing the method of the present application can be written in any combination of one or more programming languages. The program code can be provided to a processor or controller of a general-purpose computer, a special-purpose computer, or other programmable data processing apparatus, such that the program code, when executed by the processor or controller, causes functions/operations specified in a flowchart and/or a block diagram to be implemented. The program code can be executed entirely on a machine, partly on the machine, as a stand-alone software package, partly on the machine and partly on a remote machine, or entirely on the remote machine or a server.

In the context of the present application, a machine-readable medium can be a tangible medium that can contain or store a program for use by or in connection with an instruction execution system, apparatus, or device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer disk, a hard disk, a random access memory, a read-only memory, an Electronically Programmable Read-Only Memory (EPROM), a flash memory, an optical fiber, a Compact Disc Read-Only Memory (CD-ROM), an optical storage device, a magnetic storage device, or any suitable combination of the foregoing.

To provide for interaction with a user, the systems and technologies described herein can be implemented on a computer having: a display device (for example, a Cathode Ray Tube (CRT) or a Liquid Crystal Display (LCD) monitor) for displaying information to the user; and a keyboard and a pointing device (for example, a mouse or a trackball) by which the user can provide input to the computer. Other kinds of devices can also be used to provide for interaction with a user; for example, feedback provided to the user can be any form of sensory feedback (for example, visual feedback, auditory feedback, or tactile feedback); and input from the user can be received in any form, including acoustic input, speech input, or tactile input.

The systems and technologies described herein can be implemented in a computing system that includes a back-end component (for example, as a data server), or a computing system that includes a middleware component (for example, an application server), or a computing system that includes a front-end component (for example, a user computer having a graphical user interface or a Web browser through which a user can interact with an implementation of the systems and technologies described herein), or a computing system that includes any combination of such back-end, middleware, or front-end components. The components of the system can be interconnected by any form or medium of digital data communication (for example, a communication network). Examples of communication networks include: a Local Area Network (LAN), a Wide Area Network (WAN), and the Internet.

A computer system can include a client and a server. The client and the server are generally remote from each other and typically interact through a communication network. A relationship of the client and the server is generated by virtue of computer programs running on respective computers and having a client-server relationship to each other. The server can be a cloud server, can also be a server of a distributed system, or can be a server combined with a blockchain.

It should be understood that various forms of flows shown above can be used, with steps reordered, added, or deleted. For example, the steps described in the present application can be performed in parallel, in sequence, or in different orders, as long as a desired result of the technical scheme disclosed in the present application can be achieved, which is not limited herein.

The foregoing specific implementations do not constitute a limitation on the protection scope of the present application. Those skilled in the art should understand that various modifications, combinations, sub-combinations and substitutions can be made according to design requirements and other factors. Any modification, equivalent replacement, and improvement made within the spirit and principle of the present application shall be included in the protection scope of the present application.

What is claimed is:

1. A method for video understanding, comprising:
sampling a video to be processed to obtain M sampled original images, wherein M is a positive integer greater than 1;
obtaining a text recognition result of audio corresponding to the video to be processed;
determining a target input information based on the respective original images and the text recognition result;
inputting the target input information into a video understanding model to obtain a video understanding result corresponding to the video to be processed.

2. The method according to claim 1, wherein determining the target input information based on the respective original images and the text recognition result comprises:
obtaining timestamp information of respective original images respectively, and determining a target visual feature based on the respective original images and the respective timestamp information;
determining a target text feature based on the text recognition result;
determining the target input information based on the target visual feature and the target text feature.

3. The method according to claim 2, wherein determining the target visual feature based on the respective original images and the respective timestamp information comprises:
rendering the respective timestamp information into a predetermined position in a corresponding original image respectively to obtain respective target images;
determining the target visual feature based on the respective target images.

4. The method according to claim 3, wherein determining the target visual feature based on the respective target images comprises:
obtaining original visual features of respective target images respectively;
sorting respective original visual features according to the corresponding timestamp information from earlier to later, and fusing respective original visual features at odd positions with a next adjacent original visual feature respectively, and determining respective fusion results as the target visual feature.

5. The method according to claim 4, wherein
obtaining the text recognition result of audio corresponding to the video to be processed comprises: performing speech recognition on the audio using an automatic speech recognition algorithm to obtain the text recognition result, wherein the text recognition result comprises N recognized text segments, N is a positive integer greater than 1, and respective text segments correspond to an audio segment including complete semantic respectively;
determining the target text feature based on the text recognition result comprises: determining text features corresponding to respective text segments respectively, and determining the text features corresponding to respective text segments as the target text feature.

6. The method according to claim 5, wherein determining the text feature corresponding to respective text segments respectively comprises:
for any text segment, performing the following processing respectively:
obtaining a timestamp information of an audio segment corresponding to the text segment, wherein the timestamp information of the audio segment comprises: a start time timestamp of the audio segment and an end time timestamp of the audio segment;
concatenating the timestamp information with the text segment;
obtaining a text feature of a concatenation result, and determining the text feature of the concatenation result as the text feature corresponding to the text segment.

7. The method according to claim 6, wherein
obtaining the timestamp information of respective original images respectively comprises: for any original image, in response to being able to obtain absolute time information of the original image, determining the absolute time information as the timestamp information of the original image, in response to being unable to obtain the absolute time information, determining a start time of the video to be processed as time zero, and obtaining relative time information of the original image relative to the time zero, and determining the relative time information as the timestamp information of the original image;
obtaining the timestamp information of the audio segment corresponding to the text segment comprises: in response to being able to obtain absolute time information of the audio segment, determining the absolute time information as the timestamp information of the audio segment, in response to being unable to obtain the absolute time information, obtaining relative time information of the audio segment relative to the time zero, and determining the relative time information as the timestamp information of the audio segment.

8. The method according to claim 6, wherein determining the target input information based on the target visual feature and the target text feature comprises:
sorting respective target visual features according to corresponding timestamp information from earlier to later, and adding respective sorted target visual features into a first feature sequence, wherein the first feature sequence is initially empty;
for respective target text features, performing the following processing respectively: screening, from respective target visual features, a target visual feature that meets the following condition: timestamp information of corresponding two original images are both within a predetermined time range, wherein the predetermined time range is a time range defined by the start time timestamp to the end time timestamp of the audio segment corresponding to the target text feature, determining the screened target visual feature as a matching visual feature, and adding the target text feature to an adjacent position after the matching visual feature that has a latest sorting position;
determining a first feature sequence after adding respective target visual features and respective target text features as a second feature sequence, and determining the target input information based on the second feature sequence.

9. The method according to claim 8, wherein determining the target input information based on the second feature sequence comprises:
obtaining a text feature of a processing instruction corresponding to the video to be processed, wherein the processing instruction is an instruction information obtained together with the video to be processed and for describing a video understanding requirement for the video to be processed;
determining the second feature sequence and the text feature of the processing instruction as the target input information.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method for video understanding, wherein the method for video understanding comprises:
sampling a video to be processed to obtain M sampled original images, wherein M is a positive integer greater than 1;
obtaining a text recognition result of audio corresponding to the video to be processed;
determining a target input information based on the respective original images and the text recognition result;
inputting the target input information into a video understanding model to obtain a video understanding result corresponding to the video to be processed.

11. The electronic device according to claim 10, wherein determining the target input information based on the respective original images and the text recognition result comprises:
obtaining timestamp information of respective original images respectively, and determining a target visual feature based on the respective original images and the respective timestamp information;
determining a target text feature based on the text recognition result;
determining the target input information based on the target visual feature and the target text feature.

12. The electronic device according to claim 11, wherein determining the target visual feature based on the respective original images and the respective timestamp information comprises:
rendering the respective timestamp information into a predetermined position in a corresponding original image respectively to obtain respective target images;
determining the target visual feature based on the respective target images.

13. The electronic device according to claim 12, wherein determining the target visual feature based on the respective target images comprises:
obtaining original visual features of respective target images respectively;
sorting respective original visual features according to the corresponding timestamp information from earlier to later, and fusing respective original visual features at odd positions with a next adjacent original visual feature respectively, and determining respective fusion results as the target visual feature.

14. The electronic device according to claim 13, wherein
obtaining the text recognition result of audio corresponding to the video to be processed comprises: performing speech recognition on the audio using an automatic speech recognition algorithm to obtain the text recognition result, wherein the text recognition result comprises N recognized text segments, N is a positive integer greater than 1, and respective text segments correspond to an audio segment including complete semantic respectively;
determining the target text feature based on the text recognition result comprises: determining text features corresponding to respective text segments respectively, and determining the text features corresponding to respective text segments as the target text feature.

15. The electronic device according to claim 14, wherein determining the text feature corresponding to respective text segments respectively comprises:
for any text segment, performing the following processing respectively:
obtaining a timestamp information of an audio segment corresponding to the text segment, wherein the timestamp information of the audio segment comprises: a start time timestamp of the audio segment and an end time timestamp of the audio segment;
concatenating the timestamp information with the text segment;
obtaining a text feature of a concatenation result, and determining the text feature of the concatenation result as the text feature corresponding to the text segment.

16. The electronic device according to claim 15, wherein
obtaining the timestamp information of respective original images respectively comprises: for any original image, in response to being able to obtain absolute time information of the original image, determining the absolute time information as the timestamp information of the original image, in response to being unable to obtain the absolute time information, determining a start time of the video to be processed as time zero, and obtaining relative time information of the original image relative to the time zero, and determining the relative time information as the timestamp information of the original image;
obtaining the timestamp information of the audio segment corresponding to the text segment comprises: in response to being able to obtain absolute time information of the audio segment, determining the absolute time information as the timestamp information of the audio segment, in response to being unable to obtain the absolute time information, obtaining relative time information of the audio segment relative to the time zero, and determining the relative time information as the timestamp information of the audio segment.

17. The electronic device according to claim 15, wherein determining the target input information based on the target visual feature and the target text feature comprises:
sorting respective target visual features according to corresponding timestamp information from earlier to later, and adding respective sorted target visual features into a first feature sequence, wherein the first feature sequence is initially empty;
for respective target text features, performing the following processing respectively: screening, from respective target visual features, a target visual feature that meets the following condition: timestamp information of corresponding two original images are both within a predetermined time range, wherein the predetermined time range is a time range defined by the start time timestamp to the end time timestamp of the audio segment corresponding to the target text feature, determining the screened target visual feature as a matching visual feature, and adding the target text feature to an adjacent position after the matching visual feature that has a latest sorting position;
determining a first feature sequence after adding respective target visual features and respective target text features as a second feature sequence, and determining the target input information based on the second feature sequence.

18. The electronic device according to claim 17, wherein determining the target input information based on the second feature sequence comprises:
obtaining a text feature of a processing instruction corresponding to the video to be processed, wherein the processing instruction is an instruction information obtained together with the video to be processed and for describing a video understanding requirement for the video to be processed;
determining the second feature sequence and the text feature of the processing instruction as the target input information.

19. A non-transitory computer readable storage medium with computer instructions stored thereon, wherein the computer instructions are used for causing a method for video understanding, wherein the method for video understanding comprises:
sampling a video to be processed to obtain M sampled original images, wherein M is a positive integer greater than 1;
obtaining a text recognition result of audio corresponding to the video to be processed;
determining a target input information based on the respective original images and the text recognition result;
inputting the target input information into a video understanding model to obtain a video understanding result corresponding to the video to be processed.

20. The non-transitory computer readable storage medium according to claim 19, wherein determining the target input information based on the respective original images and the text recognition result comprises:
obtaining timestamp information of respective original images respectively, and determining a target visual feature based on the respective original images and the respective timestamp information;
determining a target text feature based on the text recognition result;
determining the target input information based on the target visual feature and the target text feature.
